(19) United States
(12) Patent Application Publication
(10) Pub. No.: US 2011/0273418 A1
(43) Pub. Date: Nov. 10, 2011

(54) Emission driver, light emitting display device using the same, and driving method of emission control signals

(76) Inventor: Seong-Il Park, Yongin-City (KR)

(21) Appl. No.: 12/929,622

(22) Filed: Feb. 4, 2011

(30) Foreign Application Priority Data
May 10, 2010 (KR) 10-2010-0043652

(51) Int. Cl. G09G 5/10; H05B 37/02; G09G 3/30

(52) U.S. Cl. 345/211; 315/209 R; 345/76

(57) ABSTRACT

A light emission control driver, including a first circuit unit receiving a clock signal, an input signal, and an input bar signal and generating an output bar signal, the first circuit unit being connected to a first node, a second circuit unit receiving the output bar signal, an input signal, and a clock signal and generating an output signal, the second circuit unit being connected to the first node, and a third circuit unit connected to the first node, the third circuit unit receiving the output signal and maintaining a voltage of the first node by applying a first voltage to the first node during a predetermined period responsive to the output signal.

### BACKGROUND

1. Field

Embodiments relate to an emission driver, a light emitting display device using the same, and a driving method of emission control signals.

2. Description of the Related Art

Recently, various flat panel displays adapted to reduce weight and volume, drawbacks of cathode ray tubes (CRTs), have been developed. The flat panel displays include a liquid crystal display (LCD), a field emission display (FED), a plasma display panel (PDP), an organic light emitting diode (OLED) display, and the like.

Among the flat panel displays, the OLED display displays an image by using an OLED that generates light according to recombination of electrons and holes. The OLED display receives much attention because it may provide a fast response speed, may be driven with low power consumption, and may provide high luminance and a wide viewing angle.

In the flat panel display, a plurality of pixels may be disposed in a matrix form on a substrate to form a display panel, and scan lines and data lines may be connected to the respective pixels to selectively transmit data signals to the pixels to perform display of light, an image, video, text, etc.

In general, the OLED display is classified into a passive matrix OLED (PMOLED) display and an active matrix OLED (AMOLED) display depending on how OLEDs are driven. Among them, the AMOLED display in which OLEDs are selectively driven at every unit pixel is becoming the mainstream in terms of resolution, contrast, and operation speed.

The above information disclosed in this Background section is only for enhancement of understanding of the background of the invention and therefore it may contain information that does not form the prior art.

### SUMMARY

An embodiment is directed to a light emission control driver, including a first circuit unit receiving a clock signal, an input signal, and an input bar signal and generating an output bar signal, the first circuit unit being connected to a first node, a second circuit unit receiving the output bar signal, an input signal, and a clock signal and generating an output signal, the second circuit unit being connected to the first node, and a third circuit unit connected to the first node, the third circuit unit receiving the output signal and maintaining a voltage of the first node by applying a first voltage to the first node during a predetermined period responsive to the output signal.

A low level pulse width or a high level pulse width of the input signal may be equal to a low level pulse width or a high level pulse width of the output signal.

The third circuit unit may include a first transistor having a source electrode connected to a first power source supplying the first voltage, a drain electrode connected to the first node, and a gate electrode connected to an output signal terminal to which the output signal is transmitted.

The third circuit unit may further include a second transistor having a source electrode connected to the first power source, a drain electrode connected to the source electrode of the first transistor, and a gate electrode connected to an input signal terminal to which the input signal is transmitted.

The first transistor may block supplying of the first voltage to the first node at a time that a voltage level of the output signal is changed to a gate-off voltage level.

The light emission control driver may further include a fourth circuit unit. The fourth circuit unit may be connected between the first node and a second power source, the second power source supplying a second voltage, and the fourth circuit unit may output the output signal in a gate-off voltage level by applying the second voltage to the first node during a predetermined time period for initialization.

The second voltage may be lower than the first voltage.

The fourth circuit unit may include a third transistor having a source electrode connected to the first node, a drain electrode connected to the second power source supplying the second voltage, and a gate electrode connected to a reset signal terminal to which a reset signal supplying a gate-on voltage during the predetermined time period is transmitted.

The first circuit unit may include a first switch switching the first power source supplying the first voltage by the clock signal, a second switch controlled by the input signal, and transmitting the first voltage transmitted through the first switch to the first node, a third switch connected between the first node and a second power source supplying a second voltage that is lower than the first voltage, and controlling a current to flow to the second power source from the first node responsive to a voltage of the gate electrode, a fourth switch connected between source and gate electrodes of third switch, and adjusting a voltage between the source and gate electrodes of the third switch by control of the input signal, a fifth switch controlled by the input bar signal to adjust the voltage of the gate electrode of the third switch, a sixth switch controlled by the clock signal to switch the third switch and the second power switch, and a first capacitor storing the voltage of the gate electrode of the third switch.

The second circuit unit may include a seventh switch controlled by the output bar signal to transmit the first voltage to a second node, an eighth switch connected between the second node and a second power source supplying a second voltage that is lower than the first voltage, and controlling a current to flow from the second node to the second power source responsive to a voltage of a gate electrode thereof, a ninth switch connected between source and gate electrodes of the eighth switch, and adjusting a voltage between the source and gate electrode of the eighth switch by control of the output bar signal, a tenth switch adjusting a voltage of a gate electrode of the eighth switch by control of the input signal, an eleventh switch switching the eighth switch and the second power source by control of the clock signal, and a second capacitor storing the voltage of the gate electrode of the eighth switch.

A circuit element forming the light emission control driver may be provided as a plurality of transistors that are configured by only PMOS transistors or only NMOS transistors.

Another embodiment is directed to a light emitting display device, including a display unit including a plurality of pixels respectively connected to a plurality of scan lines to which a plurality of scan signals are transmitted, a plurality of data lines to which a plurality of data signals are transmitted, and a plurality of light emission control lines to which a plurality of light emission control signals are transmitted, a scan driver generating and transmitting the scan signal to the corresponding scan line among the plurality of scan lines, a data driver transmitting a data signal to the plurality of data lines, and a light emission control driver generating and transmitting the light emission control signal to the corresponding light emission control line among the plurality of light emission control. The light emission control driver may include a first circuit unit receiving a clock signal, an input signal, and an input bar signal and generating an output bar signal, the first circuit unit being connected to a first node, a second circuit unit receiving the output bar signal, an input signal, and a clock signal and generating an output signal, the second circuit unit being connected to the first node, and a third circuit unit connected to the first node, the third circuit unit receiving the output signal and maintaining a voltage of the first node by applying a first voltage to the first node during a predetermined period responsive to the output signal.

A low level pulse width or a high level pulse width of the input signal may be equal to a low level pulse width or a high level pulse width of the output signal.

The third circuit unit may include a first transistor having a source electrode connected to a first power source supplying the first voltage, a drain electrode connected to the first node, and a gate electrode connected to an output signal terminal to which the output signal is transmitted.

The third circuit unit may include a second transistor having a source electrode connected to the first power source, a drain electrode connected to the source electrode of the first transistor, and a gate electrode connected to an input signal terminal to which the input signal is transmitted.

The light emitting display device may further include a fourth circuit unit. The fourth circuit unit may be connected between the first node and a second power source, the second power source supplying a second voltage, and the fourth circuit unit may output the output signal in a gate-off voltage level by applying the second voltage to the first node during a predetermined time period for initialization.

The fourth circuit unit may include a third transistor having a source electrode connected to the first node, a drain electrode connected to the second power source supplying the second voltage, and a gate electrode connected to a reset signal terminal to which a reset signal supplying a gate-on voltage during the predetermined time period is transmitted.

The first circuit unit may include a first switch switching the first power source supplying the first voltage by the clock signal, a second switch controlled by the input signal, and transmitting the first voltage transmitted through the first switch to the first node, a third switch connected between the first node and a second power source supplying a second voltage that is lower than the first voltage, and controlling a current to flow to the second power source from the first node responsive to a voltage of the gate electrode, a fourth switch connected between source and gate electrodes of third switch, and adjusting a voltage between the source and gate electrodes of the third switch by control of the input signal, a fifth switch controlled by the input bar signal to adjust the voltage of the gate electrode of the third switch, a sixth switch controlled by the clock signal to switch the third switch and the second power switch, and a first capacitor storing the voltage of the gate electrode of the third switch.

The second circuit unit may include a seventh switch controlled by the output bar signal to transmit the first voltage to a second node, an eighth switch connected between the second node and a second power source supplying a second voltage that is lower than the first voltage, and controlling a current to flow from the second node to the second power source responsive to a voltage of a gate electrode thereof, a ninth switch connected between source and gate electrodes of the eighth switch, and adjusting a voltage between the source and gate electrode of the eighth switch by control of the output bar signal, a tenth switch adjusting a voltage of a gate electrode of the eighth switch by control of the input signal, an eleventh switch switching the eighth switch and the second power source by control of the clock signal, and a second capacitor storing the voltage of the gate electrode of the eighth switch.

A circuit element forming the light emission control driver may be provided as a plurality of transistors that are configured by only PMOS transistors or only NMOS transistors.

The light emission control driver may include a plurality of light emission control circuits including the first circuit unit, the second circuit unit, and the third circuit unit, and each of the light emission control circuits may generate and transmit an output signal to each of the plurality of light emission control lines.

An input signal and an input bar signal transmitted to a first light emission control circuit among the plurality of light emission control circuits may be a start signal and a start bar signal.

An input signal and an input bar signal transmitted to a predetermined light emission control circuit among the plurality of light emission control circuits may be an output signal and an output bar signal output from a light emission control circuit that is previous to the predetermined light emission control circuit.

A clock signal transmitted to each of the plurality of light emission control circuits may be sequentially selected from two or more clock signals.

Another embodiment is directed to a light emission control signal driving method, including, during a first period that an input signal is transmitted in a gate-on voltage level, receiving a clock signal, the input signal, and an input bar signal, storing a first voltage responsive to the input signal, and, after a predetermined period of up to a first variation of a voltage level of the clock signal has passed, outputting an output bar signal having a voltage level of the first voltage and an output signal during a second period, the second period being equivalent to the first period; during a third period that the input signal is transmitted in a gate-off voltage level, receiving a clock signal, the input signal, and the input bar signal, decreasing the voltage level of the stored first voltage to be as low as a second voltage, outputting an output bar signal having a voltage level of the second voltage during a fourth period that is equivalent to the third period, and outputting an output signal having a voltage level of the first voltage, output of the output signal being switched by the second voltage; and receiving the output signal output during the second period, the output signal stabilizing an output terminal of the output bar signal.

The gate-on voltage level may be the second voltage level and the gate-off voltage level may be the first voltage level.

The method may further include a reset operation for transmitting the second voltage responsive to a reset signal during a predetermined time period, and outputting an output signal having the first voltage level, output of the output signal being switched by the second voltage.

### BRIEF DESCRIPTION OF THE DRAWINGS

The above and other features and advantages will become more apparent to those of skill in the art by describing in detail example embodiments with reference to the attached drawings, in which:

FIG. 1 illustrates a block diagram of a light emitting display device according to an example embodiment;

FIG. 2 illustrates a block diagram of a light emission control driver of FIG. 1 according to an example embodiment;

FIG. 3 illustrates a circuit diagram of a light emission control circuit of the light emission control driver of FIG. 2 according to an example embodiment;

FIG. 4 illustrates an example driving timing diagram of a driving waveform supplied to the light emission control driver of FIG. 2; and

FIGS. 5, 6, and 7 illustrate circuit diagrams of light emission control circuits of the light emission control driver of FIG. 2 according to example embodiments.

### DETAILED DESCRIPTION

Korean Patent Application No. 10-2010-0043652, filed on May 10, 2010, in the Korean Intellectual Property Office, and entitled: “Emission Driver, Light Emitting Display Device Using the Same, and Driving Method of Emission Control Signals,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawing figures, the dimensions of layers and regions may be exaggerated for clarity of illustration.

In various example embodiments, the same reference numerals are used for the elements having the same configuration and will be representatively described in a first example embodiment, and in other example embodiments, only elements different from those of the first example embodiment may be described. In order to clarify the description, parts that are not connected to the description may be omitted.

Throughout this specification and the claims that follow, when it is described that an element is “coupled” to another element, the element may be “directly coupled” to the other element or “electrically coupled” to the other element through a third element.

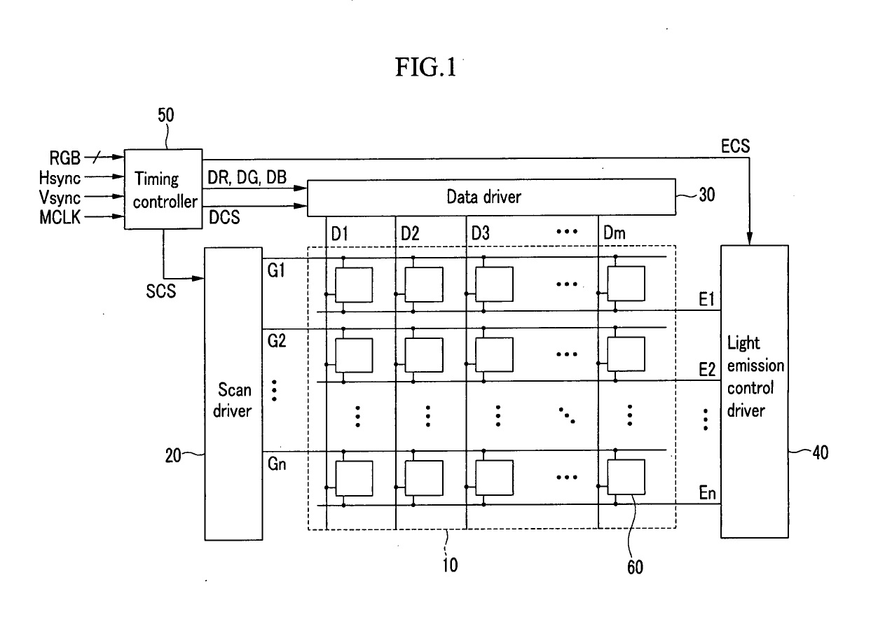

FIG. 1 illustrates a block diagram of a light emitting display device according to an example embodiment.

Referring to FIG. 1, the light emitting display device may include a display unit 10, a scan driver 20, a data driver 30, a light emission control driver 40, and a timing controller 50.

The display unit 10 may include a plurality of pixels 60 disposed at crossing areas of a plurality of scan lines G1 to Gn, a plurality of light emission control lines E1 to En, and a plurality of data lines D1 to Dm. A pixel 60 may be connected to a corresponding scan line among the plurality of scan lines G1 to Gn, a corresponding light emission control line among the plurality of light emission control lines E1 to En, and a corresponding data line among the plurality of data lines D1 to Dm.

The pixels 60 may be arranged in, e.g., a matrix format. The plurality of scan lines transmitting scan signals and the plurality of light emission control lines transmitting light emission control signals may extend in the row direction and generally in parallel with each other, and the data lines may extend in the column direction and generally in parallel with each other in the matrix format. Other arrangements may also be used.

Each pixel 60 may include a driving transistor and an organic light emitting diode (OLED). A driving transistor in a pixel 60 selected by a scan signal (transmitted through the corresponding scan line among the plurality of scan lines G1 to Gn) may receive a data voltage according to a data signal (transmitted through the corresponding data line among the plurality of data lines D1 to Dm) and supply a current according to the data voltage to the organic light emitting diode OLED for light emission with a predetermined level of luminance. In this case, light emission of the organic light emitting diode OLED of the pixel 60 may be adjusted as the flow of the current to the organic light emitting diode OLED is controlled by a light emission control signal (transmitted through the corresponding light emission control line among the plurality of light emission control lines E1 to En).

The scan driver 20 may be connected with the plurality of scan lines G1 to Gn, and may generate a scan signal and transmit the scan signal to each of the scan lines G1 to Gn. A predetermined row among the plurality of pixel rows of the display unit 10 may be selected by the scan line scan signal, and the data signal may be transmitted through the data line connected to pixels in the selected row.

The data driver 30 may be connected with the plurality of data lines D1 to Dm, and may generate a data signal and sequentially transmit the data signal to each of the plurality of pixels in the row, among the plurality of pixel rows of the display unit 10, through the data lines D1 to Dm.

The light emission control driver 40 may be connected with the plurality of light emission control lines E1 to En, and may generate a light emission control signal and transmit the light emission control signal to the plurality of light emission control lines E1 to En. The light emission control driver 40 may control a pulse width of the light emission control signal and may control the number of pulses of the light emission control signal generated in one period. The pixel 60 connected with the light emission control line of the light emission control lines E1 to En may receive the light emission control signal to determine a timing for the current generated in the pixel 60 to flow the organic light emission diode OLED. In this case, the light emission control driver 40 may be realized using PMOS transistors or NMOS transistors, e.g., all PMOS transistors or all NMOS transistors, and the display unit 10 may be formed on a substrate or may be formed as an external chip.

The timing controller 50 may generate a driving control signal to control driving of the scan driver 20, the data driver 30, and the light emission control driver 40 using a horizontal synchronization signal Hsync, a vertical synchronization signal Vsync, and a clock signal MCLK that are input from an external source. A data driving control signal DCS and a scan driving control signal SCS generated from the timing controller 50 may be respectively supplied to the data driver 30 and the scan driver 20. The timing controller 50 may generate a light emission driving control signal ECS, described in further detail below, to control an output waveform of the light emission control signal generated from the light emission control driver 40.

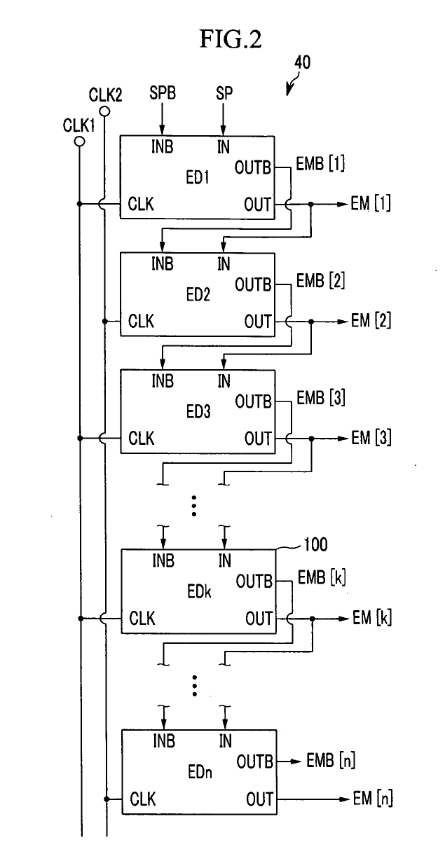

FIG. 2 illustrates a block diagram of a light emission control driver of FIG. 1 according to an example embodiment.

The light emission control driver 40 may include n light emission control circuits ED1 to EDn to generate and transmit a plurality of light emission control signals EM[1] to EM[n] to n light emission control lines E1 to En. Preferably, each of n light emission control circuits ED1 to EDn may be sequentially arranged for each row in order to be connected to the light emission control lines E1 to En connected to the pixel rows for transmission of the light emission control signals EM[1] to EM[n].

Each of the light emission control circuits ED1 to EDn may be driven by receiving at least one of clock signals CLK1 and CLK2 transmitted from two clock terminals. In an implementation, two or more clock signals transmitted from two or more clock terminals may be used.

In further detail, referring to FIG. 2, the timing controller 50 may supply two clock signals CLK1 and CLK2 (from the two clock terminals), a start signal SP, and a start bar signal SPB to the light emission control driver 40 (herein, the ‘bar’ of a signal may be represented by ‘B’ for a signal having an inverted phase or polarity, e.g., the start bar signal SPB having an inverted polarity of the start signal SP). The light emission driving control signal ECS supplied to the light emission control driver 40 from the timing controller 50 (see FIG. 1) may include the clock signals CLK1 and CLK2, the start signal SP, and the start bar signal SPB.

Among the plurality of light emission control circuits ED1 to EDn, the first clock signal CLK1 may be supplied to the odd-numbered light emission control circuits ED1, ED3, . . . , EDn−1 and the second clock signal CLK2 may be supplied to the even-numbered light emission control circuits ED2, ED4, . . . EDn. The plurality of light emission control circuits ED1 to EDn may be sequentially arranged, and they may alternately receive one of the two clock signals CLK1 and CLK2 according to the arrangement order.

Each of the plurality of light emission control circuits ED1 to EDn may have an input signal terminal IN, an input bar signal terminal INB, a clock signal terminal CLK (to which one of the two clock signals CLK1 and CLK2 is input), an output signal terminal, and an output bar signal terminal OUTB (to which an output bar signal (that is, an inverted output signal) is input).

The start signal SP and the start bar signal SPB transmitted from the timing controller 50 may be respectively supplied to an input signal terminal IN and an input bar signal terminal INB of the first light emission control circuit ED1 among the plurality of light emission control circuits ED1 to EDn. In the light emission control circuits ED2 to EDn after the first light emission control circuit ED1, an output signal generated from the previous light emission control circuit and an output bar signal (inverted from the output signal) may be respectively transmitted to an input signal terminal IN and an input bar signal terminal INB of the present light emission control circuit.

For example, an output signal EM[1] generated from the first light emission control circuit ED1 and an output bar signal EMB[1] inverted from the output signal EM[1] may be respectively supplied to the input signal terminal IN and the input bar signal terminal INB of the second light emission control circuit ED2.

Similarly, the third light emission control circuit ED3 may receive an output signal EM[2] and an output bar signal EMB[2] of the previous light emission control circuit (i.e., the second light emission control circuit ED2) through the input terminal IN and the input bar signal terminal INB thereof.

The light emission control driver 40 according to the present example embodiment may be driven by one of the clock signals externally transmitted to each of the plurality of light emission control circuits ED1 to EDn. Thus, a load may be minimized when the clock signal is supplied thereto. For example, the load of the clock signal according to the present example embodiment may be reduced approximately to ½ compared to a case that the clock signal is supplied to all the light emission control circuits.

The light emission control driver 40 according to the present example embodiment may control a pulse width of a light emission control signal continuously output from the respective light emission control circuits according to the pulse width of the start signal SP and the start bar signal SPB. Accordingly, light emission duty of the light emitting display device may be controlled.

The light emission duty of the light emitting display device may adjusted by controlling a low pulse width or a high pulse width of the light emission control signal (depending on whether a transistor of the pixel 60 is formed as a PMOS transistor or an NMOS transistor).

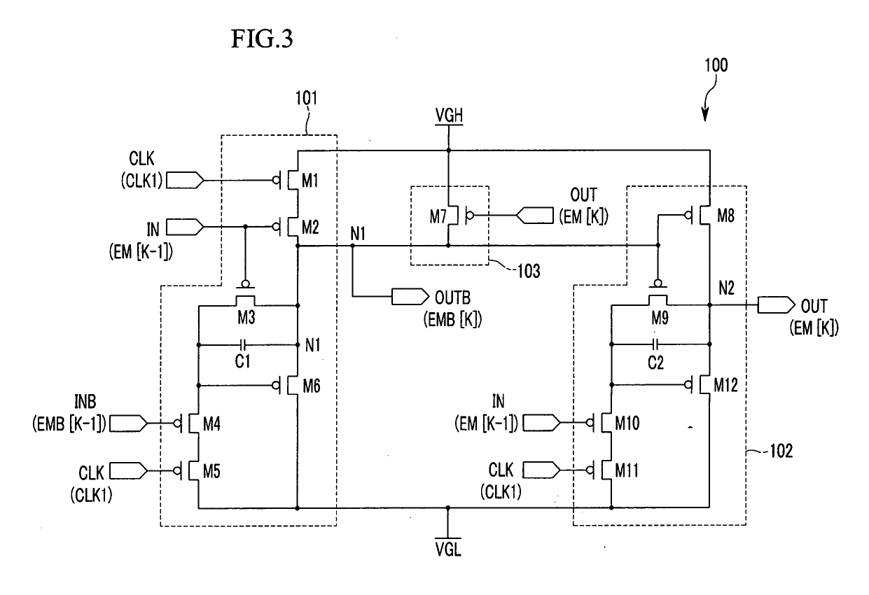

FIG. 3 illustrates, in detail, a k-th light emission control circuit 100 among the plurality of light emission control circuits ED1 to EDn forming the light emission control driver 40 of FIG. 2.

The k-th light emission control circuit 100 may bean odd-numbered light emission control circuit, and a clock signal input to a clock signal terminal CLK thereof may be the first clock signal CLK1. In addition, an output signal EM[k−1] of the (k−1)-th light emission control circuit may be input to an input signal terminal IN of the k-th light emission control circuit 100, and an output bar signal EMB[k−1] of the (k−1)-th light emission control circuit may be input to an input bar signal terminal INB.

The k-th light emission control circuit 100 may be driven by the first clock signal CLK1, and the input and input bar signals respectively input to the input signal terminal IN and the input bar signal terminal INB, and may output an output signal EM[k] and an output bar signal EMB[k]. The output signal EM[k] may be transmitted to a light emission control line connected to the k-th pixel row among the plurality of pixel rows of the display unit 10. The output signal EM[k] and the output bar signal EMB[k] may be transmitted as an input signal and an input bar signal of a (k+1)-th light emission control circuit.

Referring to FIG. 3, the k-th light emission control circuit 100 may include a first circuit unit 101, a second circuit unit 102, and a third circuit unit 103.

The first circuit unit 101 may include transistors M1 to M6 and a first capacitor C1. The first circuit unit 101 may receive the first clock signal CLK1, the output signal EM[k−1], and the output bar signal EMB[k−1] output from the (k−1)-th light emission control circuit through the clock signal terminal CLK, the input signal terminal IN, and the input bar signal terminal INB for operation.

The first circuit unit 101 may be connected to a first node N1. The first circuit unit 101 may maintain a voltage of the first node N1 at a predetermined voltage level. The first node N1 may be connected to an output bar signal terminal OUTB. An output bar signal EMB[k] having the predetermined voltage level applied to the first node N1 may be output through the output bar, signal terminal OUTB.

In an implementation, the first transistor M1 of the first circuit unit 101 may include a source electrode connected to a first power source voltage VGH, a drain electrode connected to a source electrode of a second transistor M2, and a gate electrode connected to the clock signal terminal CLK.

The second transistor M2 may include a source electrode connected to the drain electrode of the first transistor M1, a drain electrode connected to the first node N1, and a gate electrode connected to the input signal terminal IN.

The third transistor M3 may include a source electrode connected to the first node N1, a drain electrode connected to a source electrode of the fourth transistor M4, and a gate electrode connected to the input signal terminal IN.

The fourth transistor M4 may include a source electrode connected to the drain electrode of the third transistor M3, a drain electrode connected to a source electrode of the fifth transistor M5, and a gate electrode connected to the input bar signal terminal INB.

The fifth transistor M5 may include a source electrode connected to the drain electrode of the fourth transistor M4, a drain electrode connected to a second power source voltage VGL, and a gate electrode connected to the clock signal terminal CLK.

In the present example embodiment, the second power source voltage VGL may be lower than the first power source voltage VGH.

The sixth transistor M6 may include a source electrode connected to the first node N1, a drain electrode connected to the second power source voltage VGL, and a gate electrode connected to the source electrode of the fourth transistor M4.

A first end of the first capacitor C1 of the first circuit unit 101 may be connected to the first node N1, and a second end of the first capacitor C1 may be connected to the gate electrode of sixth transistor M6.

The second circuit unit 102 illustrated in FIG. 3 may be driven with an output voltage transmitted from the first circuit unit 101. Thus, the second circuit unit 102 may be driven by a voltage applied to the first node N1

The second circuit 102 may include transistors M8 to M12 and a second capacitor C2. The second circuit unit 102 may receive the voltage applied to the first node N1, and may be driven by the first clock signal CLK1 and the output signal EM[k−1] output from the (k−1)-th light emission control circuit transmitted through the clock signal terminal CLK and the input signal terminal IN.

The second circuit unit 102 may be connected to a second node N2, and may maintain a voltage of the second node N2 at a predetermined voltage level. The voltage applied to the second node N2 may be output as a voltage of the output signal EM[k] through an output signal terminal OUT connected to the second node N2.

In an implementation, the eighth transistor M8 of the second circuit unit 102 may include a source electrode connected to the first power source voltage VGH, a drain electrode connected to the second node N2, and a gate electrode connected to the first node N1.

The ninth transistor M9 may include a source electrode connected to the second node N2, a drain electrode connected to a source electrode of the tenth transistor M10, and a gate electrode connected to the first node N1.

The tenth transistor M10 may include a source electrode connected to a gate electrode of the twelfth transistor M12, a drain electrode connected to a source electrode of the eleventh transistor M11, and a gate electrode connected to the input signal terminal IN.

The eleventh transistor M11 may include a source electrode connected to the drain electrode of the tenth transistor M10, a drain electrode connected to the second power source voltage VGL, and a gate electrode connected to a clock signal terminal CLK.

The twelfth transistor M12 may include a source electrode connected to the second node N2, a drain electrode connected to the second power source voltage VGL, and a gate electrode connected to the drain electrode of the ninth transistor M9.

A first end of the second capacitor C2 of the second circuit unit 102 may be connected to the second capacitor C2, and a second end of the second capacitor C2 may be connected to the gate electrode of the twelfth transistor M12.

The k-th light emission control circuit 100 according to the present example embodiment may further include the third circuit unit 103. Referring to FIG. 3, the third circuit unit 103 may be formed of a transistor M7 connected between the first node N1 and the first power source voltage VGH.

In an implementation, the seventh transistor M7 may include a source electrode connected to the first power source voltage VGH and a drain electrode connected to the first node N1. The seventh transistor M7 may have a gate electrode connected to the output signal terminal OUT, receiving the output signal EM[k] output from the k-th light emission control circuit 100.

During the turn-on period of the seventh transistor M7, the third circuit unit 103 may apply the first power source voltage VGH to the first node N1 to stably maintain, i.e., stabilize, the voltage level of the first node N1 at a level of the first power source voltage VGH. Thus, floating of the voltage of the first node N1 (that may occur when the transistors of the first circuit unit 101 and the transistors of the second circuit unit 102 connected to the first node N1 are turned off) may be prevented so that the transistors are stably maintained in the turn-off state and operation of the light emission control circuit 100 can be stably controlled.

The transistors forming the first circuit unit 101, the second circuit unit 102, and the third circuit unit 103 may be realized as PMOS transistors, e.g., all PMOS, or NMOS transistors, e.g., all NMOS, to simplify the process through a single MOS process.

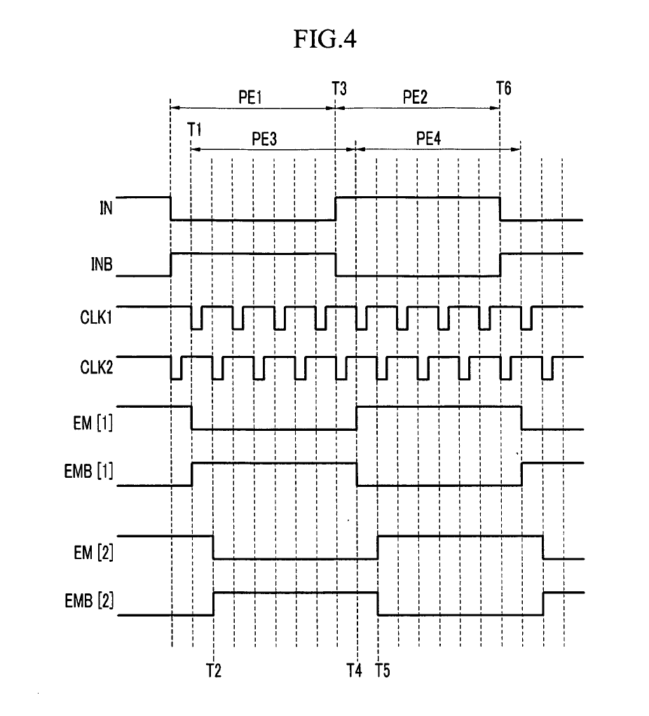

FIG. 4 illustrates an example driving timing diagram of a driving waveform supplied to the light emission control driver of FIG. 2. FIG. 4 illustrates a waveform of an output signal output through the first and second light emission control circuits, but, for better understanding and ease of description, operation of the light emission control circuit of FIG. 4 will be described with reference to a circuit diagram of the k-th light emission control circuit 100 shown in FIG. 3.

Further to the above, if the light emission control circuit of FIG. 4 is the first light emission control circuit, then an input signal IN and an input bar signal INB in the timing diagram of FIG. 4 are a start signal SP and a start bar signal SPB.

In the example waveform shown in FIG. 4, at a time T1, a first clock signal CLK1 transmitted to a first circuit unit 101 is a low-level pulse, an input signal IN becomes low level, and an input bar signal INB becomes high level. Thus, a first transistor M1, a second transistor M2, a third transistor M3, and a fifth transistor M5 of the first circuit unit 101 are turned on, and the fourth transistor M4 is turned off. Then, the first power source voltage VGH is transmitted to the first node N1 so that the output bar signal EMB[1] becomes high level of the first power source voltage VGH. In addition, since the first power source voltage VGH is transmitted through the third transistor M3, passing the first node N1, the gate electrode, and the source electrode of the sixth transistor M6 have the same voltage, so that a current flow from the source electrode to the drain electrode of the sixth transistor M6 is blocked. In this case, the first capacitor C1 maintains a voltage at both ends with the first power source voltage VGH so that a voltage of the first node N1 is maintained with the first power source voltage VGH in high level.

Meanwhile, at the time T1, since a voltage of the first node N1 transmitted to the second circuit unit 102 is high level, the eighth transistor M8 and the ninth transistor M9 are turned off The first clock signal CLK1 is a low-level pulse and the input signal IN is in low level, and therefore the tenth transistor M10 and the eleventh transistor M11 are turned on. Thus, when a gate electrode voltage of the twelfth transistor M12 is decreased by the second power source voltage VGL, the twelfth transistor M12 is turned on, and, accordingly, a voltage of the output signal EM[1] output from the output signal terminal OUT becomes low as the second power source voltage VGL.

In this case, when the output signal EM[1] of the low-level voltage is transmitted to the gate electrode of the seventh transistor M7 of the third circuit unit 103 through the output signal terminal OUT, the seventh transistor M7 is turned on and transmits the first power source voltage VGH to the first node N1. Then, the eighth transistor M8 and the ninth transistor M9 are maintained in the turned-off state by maintaining the first node N1 without floating, and, accordingly, the output signal EM[1] can be stably output with a low-level pulse width.

For a period PE1 during which the input signal IN maintains the low level state, the first clock signal CLK1 transmits a plurality of pulses, each having 2 horizontal cycles. The third circuit unit 103 according to the example embodiment can prevent floating occurring when switching operation of transistors receiving the first clock signal CLK1 is changed due to high-level and low-level voltage variation as the first clock signal CLK1 transmits the plurality of pulses during the period PE1.

During the period PE1 that the input signal IN is in low level, the first output signal EM[1] is output as a low level signal at the time T1 that the transmission pulse of the first clock signal CLK1 is first transmitted in low level, and is maintained at the low level during a period that is equivalent to or has a duration equal to the period PE1. Thus, during a period PE3, the output signal EM[1] of the low level voltage is supplied to the first light emission control line.

The output signal EM[1] and the output bar signal EMB[1] function as an input signal and an input bar signal of the second light emission control circuit, and the second light emission control circuit receives the second clock signal CLK2 for operation. The process is the same the above and a detailed repetition thereof will be omitted.

The second output signal EM[2] generated from the second light emission control circuit is output as a low level signal at a time T2, where at time T2 the transmission pulse of the second clock signal CLK2 is first transmitted in low level during a period PE3, where, in the period PE3, the first output signal EM[1] (that functions as the input signal IN) is in the low level and maintains the low level during a period that is the same as the period PE3. Thus, at the time T2, the output signal EM[2] having a low level voltage is supplied to the second light emission control line during the period that is the same as or has the same duration as the period PE3.

Meanwhile, although the input signal IN is increased to a high level at times T3 and T4 and the pulse of the first clock signal CLK1 is transmitted as a high level voltage, the voltage at the first node N1 stably maintains a high voltage by the first power source voltage VGH charged at both ends of the first capacitor C1 and the operation of the third circuit unit 103, and the voltages charged at both ends of the second capacitor C maintain the second power source voltage VGL so that the output signal EM[1] is maintained in the low level.

When the input signal IN is at a high level and the input bar signal INB is at a low level at the time T4, the first clock signal CLK1 is transmitted as a low level pulse.

The first circuit unit 101, the first transistor M1, the fourth transistor M4, and the transistor M5 receiving the above signals are turned on, and the second transistor M2 and the third transistor M3 are turned off. Then, the first power source voltage VGH is not transmitted to the first node N1. In addition, the gate electrode voltage of the sixth transistor M6 is decreased by the fourth transistor M4 and the fifth transistor M5, and, accordingly, the sixth transistor M6 is turned on and the voltage of the first node N1 is gradually decreased by the second power source voltage VGL.

Thus, the voltage of the first node N1 becomes low level, and the output bar signal EMB[1] connected to the first node N1 becomes low level. In addition, a low level voltage is transmitted to the second circuit unit 102 through the first node N1. Since the voltage of the first node N1 is in low level, the eighth transistor M8 and the ninth transistor M9 are turned on, and the first power source voltage VGH is transmitted to the second node N2 through the eighth transistor M8. Then, the voltage of the output signal EM[1] (output from the output signal terminal OUT connected to the second node N2) is output in high level that is the same level of the first power source voltage VGH.

In this case, the first power source voltage VGH transmitted to the second node N2 is transmitted to the gate electrode of the twelfth transistor M12 through the ninth transistor M9. Then, the gate electrode and the source electrode of the twelfth transistor M12, diode-connected by the ninth transistor M9, have the same voltage so that a current flow from the source electrode to the drain electrode the twelfth transistor M12 is blocked. Since the both end voltages of the second capacitor C2 are charged with a voltage level of the first power source voltage VGH, the gate electrode and the source electrode of the twelfth transistor M12 maintain the same voltage level. In addition, since the tenth transistor M10 of the second circuit 10 is turned off during the period PE2 that the input signal IN is maintained in high level, without regard to the high-level or low-level voltage transmission of the first clock signal CLK1, the gate electrode voltage of the twelfth transistor M12 is not decreased.

Meanwhile, since the voltage of the output signal EM[1] is in high level, the seventh transistor M7 of the third circuit unit 103 is turned off during a period PE4 so that no current flows through the seventh transistor M7.

The first output signal EM[1] is output at a high level at a time T4, where at time T4 the transmission pulse of the first clock signal CLK1 is first transmitted in low level during the period PE4, where, in the period PE4, the input signal IN is at a high level and is maintained at the high level during the period PE4 that is the same as the period PE2. Thus, the output signal EM[1] of the high level voltage is supplied to the first light emission control line during the period PE4.

Similarly, the high-level output signal EM[1] and the low-level output bar signal EMB[1] function as an input signal and an input bar signal of the second light emission control circuit, and the second light emission control circuit receives the second clock signal for operation. The process is the same as the above and a repetition thereof will be omitted.

According to the present example embodiment, the light emission control circuit can be formed of relatively few transistors, and a light emission duty ratio of an output signal, output as a light emission control signal to the corresponding light emission control line, can be controlled by adjusting a pulse width of an input signal IN. Further, the light emission control driver according to the present example embodiment may stably control voltage application to the first node M1 through the third circuit unit 103. Thus, driving operation of the light emission control circuit may be more precisely realized to thereby transmit a light emission control signal for precise light emission duty to the display unit 10. Accordingly, the layout size in circuit design of the light emitting display device may be reduced and product failure occurrence probability may be reduced, such that the light emitting display device having an excellent quality characteristic may be provided.

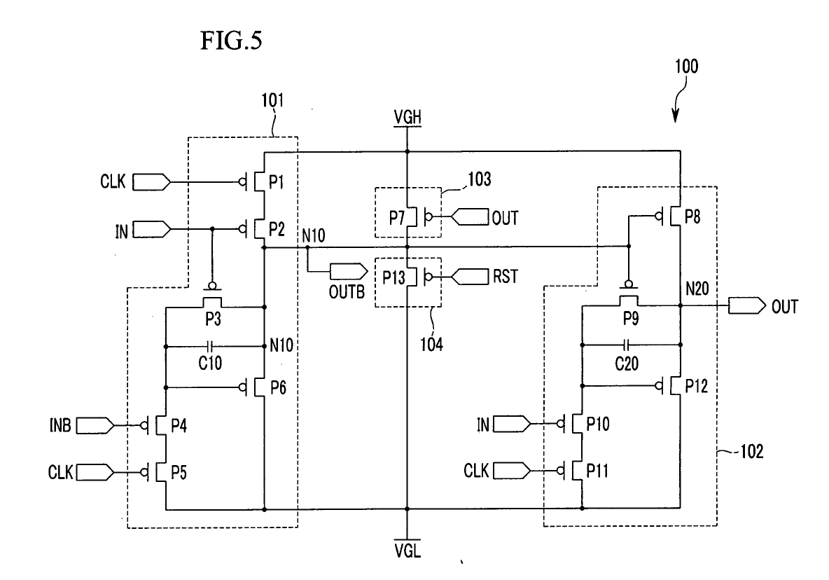

FIGS. 5, 6, and 7 illustrate circuit diagrams of light emission control circuits of the light emission control driver of FIG. 2 according to example embodiments.

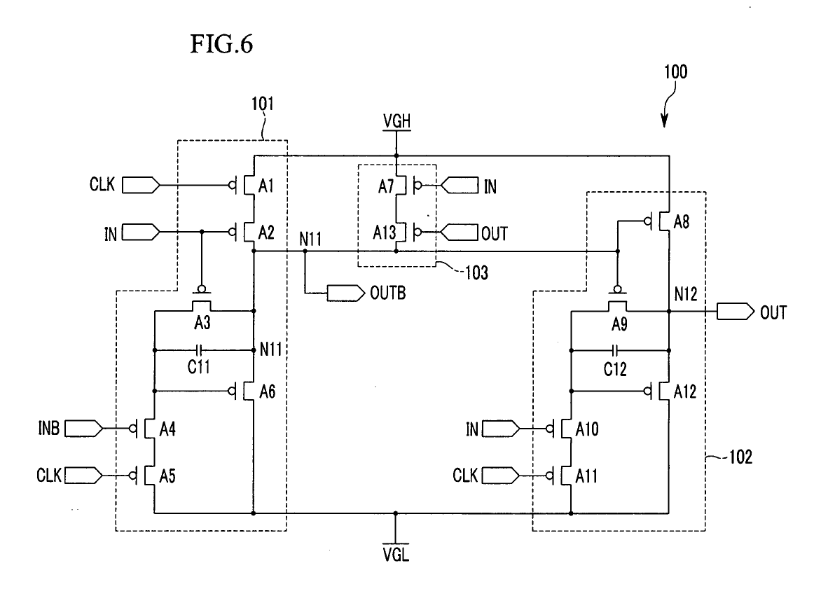

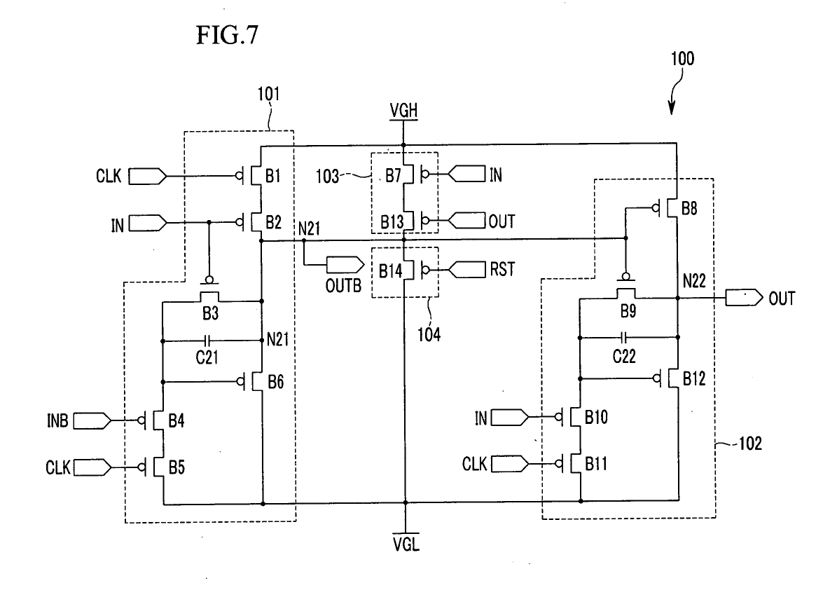

Structures of examples of the light emission control circuit 100 in FIGS. 5, 6, and 7 are similar to the structure of the light emission control circuit shown in FIG. 3. The examples of the light emission control circuit 100 in FIGS. 5, 6, and 7 include a first circuit unit 101 and a second circuit unit 102. Transistors P1 to P6 and a first capacitor C10 are included in the first circuit unit 101 of the light emission control circuit 100 of FIG. 5. Transistors A1 to A6 and a first capacitor C11 are included in the first circuit unit 101 of the light emission control circuit 100 of FIG. 6. Transistors B1 to B6 and a first capacitor C21 are included in the first circuit unit 101 of the light emission control circuit 100 of FIG. 7. The above are the same as the transistors M1 to M6 and the first capacitor C1 of the first circuit 101 of FIG. 3 in structure, and are driven by the same driving operation.

Similarly, transistors P8 to P12 and a second capacitor C20 are included in the second circuit unit 102 of FIG. 5. Transistors A8 to A12 and a second capacitor C12 are included the second circuit unit 102 of FIG. 6. Transistors B8 to B12 and a second capacitor C22 are included the second circuit unit 102 of FIG. 7. The above have the same structure and the same driving operation as for the transistors M8 to M12 forming the second circuit 102 of FIG. 3. Thus, portions of the light emission control circuit 100, which have been described with reference to FIG. 3 and FIG. 4, will not be further described, and only different portions will be described.

Like the light emission control 100 of FIG. 3, the light emission control circuit 100 of FIG. 5 may include a third circuit unit 103 formed of a seventh transistor P7, a gate electrode of which is connected to an output signal terminal OUT. However, the light emission control circuit 100 of FIG. 5 may further include a fourth circuit unit 104 connected to a first node N10.

Referring to FIG. 5, the fourth circuit unit 104 may be formed of a thirteenth transistor P13 connected between the first node N10 and a second power source voltage VGL. The thirteenth transistor P13 may include a source electrode connected to the first node N10, a drain electrode connected to the second power source voltage VGL, and a gate electrode connected to a reset signal terminal RST.

The fourth circuit unit 104 may be used as an initializing circuit to prevent instant light emission of the entire area of a display unit 10, which occurs when a light emission control signal output from a light emission control driver 40 is not initialized, at initial power connection (i.e., initial power ON).

The thirteenth transistor P13 receives a reset signal applied as a low-level pulse through a gate electrode during a predetermined period at the initial power connection stage of the light emitting display device. Then, the thirteenth transistor P13 is turned on and a high-level output signal is transmitted to the output signal terminal OUT. Such an operation may be performed in all of a plurality of light emission control circuits 100 forming the light emission control driver 40, and, accordingly, the entirety of the pixels of the display unit 10 may be reset. During other periods than the predetermined period, the reset signal may be transmitted as a high-level pulse so that the fourth circuit unit 104 does not influence operation of the light emission control circuit 100.

A light emission control circuit 100 of FIG. 6 further includes a seventh transistor A7 that receives an input signal from an input signal terminal IN for operation when forming the third circuit unit 103.

In further detail, referring to FIG. 6, the third circuit unit 103 may include the seventh transistor A7 and a thirteenth transistor A13. The seventh transistor A7 may include a source electrode connected to a first power source voltage VGH, a drain electrode connected to a source electrode of the thirteenth transistor A13, and a gate electrode connected to the input signal terminal IN. The thirteenth transistor A13 may include a source electrode connected to the drain electrode of the seventh transistor A7, a drain electrode connected to a first node N11, and a gate electrode connected to an output signal terminal OUT to which an output signal is transmitted.

In the example embodiment of FIG. 6, the third circuit unit 103 may include the seventh transistor A7 in addition to the thirteenth transistor A13 in order to prevent floating of the first node N11. In an example operation, the seventh transistor A7 is turned off prior to the thirteenth transistor A13 using a pulse cycle difference between an output signal and an input signal input to each transistor, so as to smooth a racing condition when a voltage of the first node N11 connected with an output bar signal terminal OUTB is changed to low level.

A light emission control circuit 100 according to an example embodiment of FIG. 7 has a circuit structure in which additional constituent elements of the light emission control circuits of FIG. and FIG. 6 are combined together.

Referring to FIG. 7, the light emission control circuit 100 of FIG. 7 may further include a fourth circuit unit 104 formed of a fourteenth transistor B14. In addition, the third circuit unit 103 of the light emission control circuit 100 may further include a seventh transistor B7 having a gate electrode connected between the first power source voltage VGH and the thirteenth transistor B13 and connected to the input signal terminal in addition to the thirteenth transistor B13 connected to the output signal terminal OUT. The third circuit unit 103 and the fourth circuit unit 104 of FIG. 7 may be the same as the third circuit unit 103 and the fourth circuit unit 104 of FIG. 5 and FIG. 6, and therefore no further description will be provided.

As display panels increase in size, and as excellent motion picture image quality with reduced motion blur have been required, research and development of a light emission control driver that drives light emission of a plat display device are required. In this regard, as described above, embodiments relate to a light emission control driver, a light emitting display device using the same, and a light emission control signal driving method. Embodiments may reduce the size, the weight, and cost when using a single MOS process of a PMOS or NMOS transistor.

Embodiments may provide a light emission control driver having an advantage of generating a light emission control signal of which a light emission duty ratio is adjusted to acquire black data insertion in realization of a motion picture image quality that is reduced in motion blur. Embodiments may also provide a driving method of a light emission control signal generated from the same.

In addition, embodiments may provide a light emitting display device that is advantageous in size, weight, and production cost reduction by developing a circuit structure of a light emission control driver, which can be applied to a single MOS process of a PMOS or NMOS transistor with various shapes so that it can be externally attached as an individual integrated chip (IC) or integrated into glass of the light emitting display device. According to embodiments, the number of constituent elements may be significantly reduced and, simultaneously, the number of necessary signals may be reduced. Thus, a high image quality of the light emitting display device may be realized through a simple circuit structure of the light emission control driver. In addition, according to embodiments, the constituent circuit of the light emitting display device may be simplified so that the layout area is greatly reduced, the weight, the size, and the production cost can be reduced, and error generation probability is decreased, thereby providing an economic and reliable product.

<Description of symbols>

| | |
|---|---|
| 10: display unit | 20: scan driver |

| | |
|---|---|
| 30: data driver | 40: light emission control driver |

| 50: timing controller 60: pixel | |
|---|---|
| 100: light emission control circuit 101: first circuit unit | |
| 102: second circuit unit | 103: third circuit unit |

104: fourth circuit unit

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A light emission control driver, comprising:
a first circuit unit receiving a clock signal, an input signal, and an input bar signal and generating an output bar signal, the first circuit unit being connected to a first node;
a second circuit unit receiving the output bar signal, an input signal, and a clock signal and generating an output signal, the second circuit unit being connected to the first node; and
a third circuit unit connected to the first node, the third circuit unit receiving the output signal and maintaining a voltage of the first node by applying a first voltage to the first node during a predetermined period responsive to the output signal.

2. The light emission control driver as claimed in claim 1, wherein a low level pulse width or a high level pulse width of the input signal is equal to a low level pulse width or a high level pulse width of the output signal.

3. The light emission control driver as claimed in claim 1, wherein the third circuit unit includes a first transistor having a source electrode connected to a first power source supplying the first voltage, a drain electrode connected to the first node, and a gate electrode connected to an output signal terminal to which the output signal is transmitted.

4. The light emission control driver as claimed in claim 3, wherein the third circuit unit further includes a second transistor having a source electrode connected to the first power source, a drain electrode connected to the source electrode of the first transistor, and a gate electrode connected to an input signal terminal to which the input signal is transmitted.

5. The light emission control driver as claimed in claim 3, wherein the first transistor blocks supplying of the first voltage to the first node at a time that a voltage level of the output signal is changed to a gate-off voltage level.

6. The light emission control driver as claimed in claim 1, further comprising a fourth circuit unit, wherein:
the fourth circuit unit is connected between the first node and a second power source, the second power source supplying a second voltage, and
the fourth circuit unit outputs the output signal in a gate-off voltage level by applying the second voltage to the first node during a predetermined time period for initialization.

7. The light emission control driver as claimed in claim 6, wherein the second voltage is lower than the first voltage.

8. The light emission control driver as claimed in claim 6, wherein the fourth circuit unit includes a third transistor having a source electrode connected to the first node, a drain electrode connected to the second power source supplying the second voltage, and a gate electrode connected to a reset signal terminal to which a reset signal supplying a gate-on voltage during the predetermined time period is transmitted.

9. The light emission control driver as claimed in claim 1, wherein the first circuit unit includes:
a first switch switching the first power source supplying the first voltage by the clock signal;
a second switch controlled by the input signal, and transmitting the first voltage transmitted through the first switch to the first node;
a third switch connected between the first node and a second power source supplying a second voltage that is lower than the first voltage, and controlling a current to flow to the second power source from the first node responsive to a voltage of the gate electrode;
a fourth switch connected between source and gate electrodes of third switch, and adjusting a voltage between the source and gate electrodes of the third switch by control of the input signal;
a fifth switch controlled by the input bar signal to adjust the voltage of the gate electrode of the third switch;
a sixth switch controlled by the clock signal to switch the third switch and the second power switch; and
a first capacitor storing the voltage of the gate electrode of the third switch.

10. The light emission control driver as claimed in claim 1, wherein the second circuit unit includes:
a seventh switch controlled by the output bar signal to transmit the first voltage to a second node;
an eighth switch connected between the second node and a second power source supplying a second voltage that is lower than the first voltage, and controlling a current to flow from the second node to the second power source responsive to a voltage of a gate electrode thereof;
a ninth switch connected between source and gate electrodes of the eighth switch, and adjusting a voltage between the source and gate electrode of the eighth switch by control of the output bar signal;
a tenth switch adjusting a voltage of a gate electrode of the eighth switch by control of the input signal;
an eleventh switch switching the eighth switch and the second power source by control of the clock signal; and
a second capacitor storing the voltage of the gate electrode of the eighth switch.

11. The light emission control driver as claimed in claim 1, wherein a circuit element forming the light emission control driver is provided as a plurality of transistors that are configured by only PMOS transistors or only NMOS transistors.

12. A light emitting display device, comprising:
a display unit including a plurality of pixels respectively connected to a plurality of scan lines to which a plurality of scan signals are transmitted, a plurality of data lines to which a plurality of data signals are transmitted, and a plurality of light emission control lines to which a plurality of light emission control signals are transmitted;
a scan driver generating and transmitting the scan signal to the corresponding scan line among the plurality of scan lines;
a data driver transmitting a data signal to the plurality of data lines; and
a light emission control driver generating and transmitting the light emission control signal to the corresponding light emission control line among the plurality of light emission control, wherein the light emission control driver includes:
a first circuit unit receiving a clock signal, an input signal, and an input bar signal and generating an output bar signal, the first circuit unit being connected to a first node,
a second circuit unit receiving the output bar signal, an input signal, and a clock signal and generating an output signal, the second circuit unit being connected to the first node, and
a third circuit unit connected to the first node, the third circuit unit receiving the output signal and maintaining a voltage of the first node by applying a first voltage to the first node during a predetermined period responsive to the output signal.

13. The light emitting display device as claimed in claim 12, wherein a low level pulse width or a high level pulse width of the input signal is equal to a low level pulse width or a high level pulse width of the output signal.

14. The light emitting display device as claimed in claim 12, wherein the third circuit unit includes a first transistor having a source electrode connected to a first power source supplying the first voltage, a drain electrode connected to the first node, and a gate electrode connected to an output signal terminal to which the output signal is transmitted.

15. The light emitting display device as claimed in claim 14, wherein the third circuit unit includes a second transistor having a source electrode connected to the first power source, a drain electrode connected to the source electrode of the first transistor, and a gate electrode connected to an input signal terminal to which the input signal is transmitted.

16. The light emitting display device as claimed in claim 12, further comprising a fourth circuit unit, wherein:
the fourth circuit unit is connected between the first node and a second power source, the second power source supplying a second voltage, and
the fourth circuit unit outputs the output signal in a gate-off voltage level by applying the second voltage to the first node during a predetermined time period for initialization.

17. The light emitting display device as claimed in claim 16, wherein the fourth circuit unit includes a third transistor having a source electrode connected to the first node, a drain electrode connected to the second power source supplying the second voltage, and a gate electrode connected to a reset signal terminal to which a reset signal supplying a gate-on voltage during the predetermined time period is transmitted.

18. The light emitting display device as claimed in claim 12, wherein the first circuit unit includes:
a first switch switching the first power source supplying the first voltage by the clock signal;
a second switch controlled by the input signal, and transmitting the first voltage transmitted through the first switch to the first node;
a third switch connected between the first node and a second power source supplying a second voltage that is lower than the first voltage, and controlling a current to flow to the second power source from the first node responsive to a voltage of the gate electrode;
a fourth switch connected between source and gate electrodes of third switch, and adjusting a voltage between the source and gate electrodes of the third switch by control of the input signal;
a fifth switch controlled by the input bar signal to adjust the voltage of the gate electrode of the third switch;
a sixth switch controlled by the clock signal to switch the third switch and the second power switch; and
a first capacitor storing the voltage of the gate electrode of the third switch.

19. The light emitting display device as claimed in claim 12, wherein the second circuit unit includes:
a seventh switch controlled by the output bar signal to transmit the first voltage to a second node;
an eighth switch connected between the second node and a second power source supplying a second voltage that is lower than the first voltage, and controlling a current to flow from the second node to the second power source responsive to a voltage of a gate electrode thereof;
a ninth switch connected between source and gate electrodes of the eighth switch, and adjusting a voltage between the source and gate electrode of the eighth switch by control of the output bar signal;
a tenth switch adjusting a voltage of a gate electrode of the eighth switch by control of the input signal;
an eleventh switch switching the eighth switch and the second power source by control of the clock signal; and
a second capacitor storing the voltage of the gate electrode of the eighth switch.

20. The light emitting display device as claimed in claim 12, wherein a circuit element forming the light emission control driver is provided as a plurality of transistors that are configured by only PMOS transistors or only NMOS transistors.

21. The light emitting display device as claimed in claim 12, wherein the light emission control driver includes a plurality of light emission control circuits including the first circuit unit, the second circuit unit, and the third circuit unit, and each of the light emission control circuits generates and transmits an output signal to each of the plurality of light emission control lines.

22. The light emitting display device as claimed in claim 21, wherein an input signal and an input bar signal transmitted to a first light emission control circuit among the plurality of light emission control circuits are a start signal and a start bar signal.

23. The light emitting display device as claimed in claim 21, wherein an input signal and an input bar signal transmitted to a predetermined light emission control circuit among the plurality of light emission control circuits are an output signal and an output bar signal output from a light emission control circuit that is previous to the predetermined light emission control circuit.

24. The light emitting display device as claimed in claim 21, wherein a clock signal transmitted to each of the plurality of light emission control circuits is sequentially selected from two or more clock signals.

25. A light emission control signal driving method, comprising:
during a first period that an input signal is transmitted in a gate-on voltage level:
receiving a clock signal, the input signal, and an input bar signal, storing a first voltage responsive to the input signal, and, after a predetermined period of up to a first variation of a voltage level of the clock signal has passed, outputting an output bar signal having a voltage level of the first voltage and an output signal during a second period, the second period being equivalent to the first period;
during a third period that the input signal is transmitted in a gate-off voltage level:
receiving a clock signal, the input signal, and the input bar signal, decreasing the voltage level of the stored first voltage to be as low as a second voltage, outputting an output bar signal having a voltage level of the second voltage during a fourth period that is equivalent to the third period, and outputting an output signal having a voltage level of the first voltage, output of the output signal being switched by the second voltage; and
receiving the output signal output during the second period, the output signal stabilizing an output terminal of the output bar signal.

26. The method as claimed in claim 25, wherein the gate-on voltage level is the second voltage level and the gate-off voltage level is the first voltage level.

27. The method as claimed in claim 25, further comprising:
a reset operation for transmitting the second voltage responsive to a reset signal during a predetermined time period; and
outputting an output signal having the first voltage level, output of the output signal being switched by the second voltage.
